(19) United States
(12) Patent Application Publication
(10) Pub. No.: US 2015/0162686 A1
(43) Pub. Date: Jun. 11, 2015

(54) ELECTRIC CONNECTOR FOR FLAT CONDUCTOR AND ASSEMBLY METHOD FOR ELECTRIC CONNECTOR AND FLAT CONDUCTOR

(71) Applicants: Jigao Qian, Dongguan (CN); Jun Wan, Dongguan (CN); Shangsheng Cai, Dongguan (CN); Guangcai Hu, Dongguan (CN); Ya Zhou, Dongguan (CN)

(72) Inventors: Jigao Qian, Dongguan (CN); Jun Wan, Dongguan (CN); Shangsheng Cai, Dongguan (CN); Guangcai Hu, Dongguan (CN); Ya Zhou, Dongguan (CN)

(73) Assignee: DONGGUAN YUQIU ELECTRONICS CO., LTD., Taipei (TW)

(21) Appl. No.: 14/396,735

(22) PCT Filed: Jun. 25, 2012
(86) PCT No.: PCT/CN2012/077439

§ 371 Date: Jan. 20, 2015

(30) Foreign Application Priority Data
Apr. 24, 2012 (CN) 201210121721.9

(51) Int. Cl. H01R 12/79; H01R 43/027; H01R 24/60

(52) U.S. Cl. CPC H01R 12/79; H01R 24/60; H01R 43/027

(57) ABSTRACT

The present invention discloses an electric connector for flat conductor and an assembly method for the electric connector and the flat conductor, comprising an insulating body and a shielding housing. A guiding slot for insertion of the flat conductor is provided inside the insulating body. Two insert slots are provided on the insulating body at positions corresponding to two notches of the flat conductor. The insert slots are connected between the guiding slot and an external side of the insulating body along a thickness direction of the flat conductor. An elastic buckling piece connected integrally to the insulating body is disposed inside the insert slot. In the natural state, a buckling part of the elastic buckling piece extends into the guiding slot. During assembly, the flat conductor is inserted to push the elastic buckling piece open, and after the flat conductor is inserted completely, the elastic buckling piece is automatically reset to buckle the flat conductor. Alternatively, during assembly, a jig is used to prop the buckling part first; after the flat conductor is inserted completely, the jig is removed, and the elastic buckling piece is automatically reset to buckle the flat conductor. The structure is simple and easy to produce, and the assembly is convenient, thereby effectively improving the production efficiency and production quality.

### BACKGROUND OF INVENTION

1. Field of the Invention

The present invention relates generally to an electric connector, and more particularly to an electric connector for flat conductor which is used for the LCD signal transmission and assembly for electric connector and flat conductor.

2. Description of Related Art

With the rapid development of network and communication technology, the consumers' demands for the transmission speed are increasing. The electric connectors used in computers and electronic products must be able to transmit high-frequency and high-speed signals. Therefore, the connector of low voltage differential signal (LVDS) has been developed in recent years, which utilizes high-speed vibration of extremely low voltage amplitude to transmit the data. It has the advantages of low power consumption and low bit error rate.

The main structure of existing LVDS connector comprises an insulating body and a shielding housing. The insulating body has a front and a rear opening space. The flat conductor is inserted into the rear opening, and the connecting part of the flat conductor is at the front opening. In order to avoid the loosening and falling of the flat conductor (such as FPC or FFC), a notch is provided on the flat conductor, and a limiting device is affixed to the notch to stabilize the flat conductor. However, the structure of the limiting device of conventional LVDS connector is complex and the assembly method is complicated, which affects the production efficiency.

Therefore, a new technical scheme needs to be developed to address said problem.

### SUMMARY OF THE INVENTION

The primary objective of the present invention is to provide an electric connector for flat conductor, where the flat conductor is inserted to push the elastic buckling piece open, and then the elastic buckling piece is automatically reset to buckle the flat conductor. The structure is simple and easy to produce, and can firmly secure the flat conductor, thereby effectively improving the production efficiency and product quality.

The second objective is to provide an electric connector for flat conductor, where a jig is used to prop the buckling part first; after the flat conductor is inserted completely, the jig is removed, and the elastic buckling piece is automatically reset to buckle the flat conductor. The structure is simple and easy to produce, and can firmly secure the flat conductor, thereby effectively improving the production efficiency and product quality.

The third objective is to provide an assembly method for electric connector and flat conductor. The assembly method is simple and easy to operate, thereby effectively improving the assembly efficiency and reducing the production cost.

To realize said purposes, the present invention adopts the following technical scheme:

An electric connector for flat conductor, comprising at least an insulating body, a guiding slot for insertion of the flat conductor is provided at the front opening of the flat conductor; on the opposite side, an inserting part is provided for insertion with the corresponding connector; on the inserting part, there is an inserting slot for connection with said guiding slot; the connecting part of the flat conductor is inserted into the guiding slot and is positioned at said inserting part to be in contact with the connector; according to the position of the two notches on the flat conductor, there is an insert slot across the guiding slot on the insulating body along a thickness direction of the flat conductor.

In the insert slot, an elastic buckling piece is formed integrally on the insulating body. Said elastic buckling piece comprises an elastic arm extending laterally on the insulating body and a buckling part protruding vertically; said buckling part protrudes into the guiding slot, after the flat conductor is inserted completely, the buckling part is buckled at the notch of the flat conductor with the rebound action of elastic arm, in order to prevent the flat conductor from falling.

As a preferred embodiment, a guiding slope is provided on said buckling part for the convenience of inserting the flat conductor. By pushing the guiding slope of the buckling part of the flat conductor, the buckling part is pushed up automatically under the elastic action of the elastic arm, allowing the flat conductor to be inserted easily. Finally, the buckling part is buckled to the notch of the flat conductor with the rebound action of elastic arm.

As a preferred embodiment, said buckling part is provided with a pressed part at the external side of flat conductor. Said pressed part is pushed by the external jig, and drives and pushes the buckling part up, thus allowing the flat conductor to be inserted. Finally, said buckling part is buckled at the notch of flat conductor with the rebound action of elastic arm.

As a preferred embodiment, said buckling part is equipped with a receding groove along the thickness direction of the flat conductor to provide flexibility for the movement of guiding part.

As a preferred embodiment, the left and right sides of said inserting part are provided with a limiting part respectively for stopping the front part of the flat conductor.

As a preferred embodiment, the front part of said insert slot is provided with an anti-warping part for stopping the front part of the flat conductor.

As a preferred embodiment, said connector comprises a shielding housing and left and right hooks.

As a preferred embodiment, said shielding housing and left and right hooks are formed integrally. Said hook comprises of the stopping part, elastic compression part and hook part. Said stopping part is connected integrally onto the shielding housing.

An electric connector for flat conductor and assembly for electric connector and flat conductor defined in claim 3, its assembly procedure is as follows:

(1) Prepare an electric connector for flat conductor, a flat conductor and a jig; said jig is provided with a pushing block;

(2) Utilize the pushing block of said jig to push the pressed part upwards in the preset procedure so that the pressed part drives and pushes the buckling part upwards under the action of the elastic arm; the flat conductor can thus pass through the pressed part by zero insertion force;

(3) Insert the flat conductor from the guiding slot, putting the connecting part at its front part on the inserting part;

(4) Release the jig and the buckling part restores back to its natural state under the rebound action of elastic arm. Then, the buckling part is extended into the guiding slot and buckled in the notch of the flat conductor.

As a preferred embodiment, said electric connector for flat conductor has any of the structure defined in claims 4 to 8.

Compared with the prior art, the present invention has obvious advantages and beneficial effects, in particular, as revealed in the above technical scheme:

1. The flat conductor is buckled by the elastic buckling piece formed integrally on the insulating body. In the natural state, the buckling part of the elastic buckling piece extends into the guiding slot where the flat conductor is located. During assembly, the flat conductor is inserted to push the elastic buckling piece open. After the flat conductor is inserted completely, the elastic buckling piece is automatically reset to buckle the flat conductor. The structure is simple and easy to produce, and can firmly secure the flat conductor, thereby effectively improving the production efficiency and product quality.

2. The flat conductor is buckled by the elastic buckling piece formed integrally on the insulating body. In the natural state, the buckling part of the elastic buckling piece extends into the guiding slot where the flat conductor is located. During assembly, a jig is used to prop the buckling part first; after the flat conductor is inserted completely, a jig is removed, and the elastic buckling piece is automatically reset to buckle the flat conductor. The structure is simple and easy to produce, and can firmly secure the flat conductor, thereby effectively improving the production efficiency and product quality.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of the first embodiment of the present invention;

FIG. 2 is an exploded view of the first embodiment of the present invention;

FIG. 3 is a schematic view of the flat conductor insertion process in the first embodiment of the present invention;

FIG. 4 is a schematic view of the flat conductor insertion process of the first embodiment of the present invention;

FIG. 5 is a schematic view of the flat conductor insertion process of the first embodiment of the present invention;

FIG. 6 is an enlarged view of the section at location B-B in FIG. 1;

FIG. 7 is an enlarged view of the section at location C-C in FIG. 1;

FIG. 8 is a perspective view of another assembly in the preferred embodiment of the present invention;

FIG. 9 is a perspective view of the second embodiment of the present invention;

FIG. 10 is an enlarged view of location D in FIG. 9.

### DETAILED DESCRIPTION OF THE INVENTION

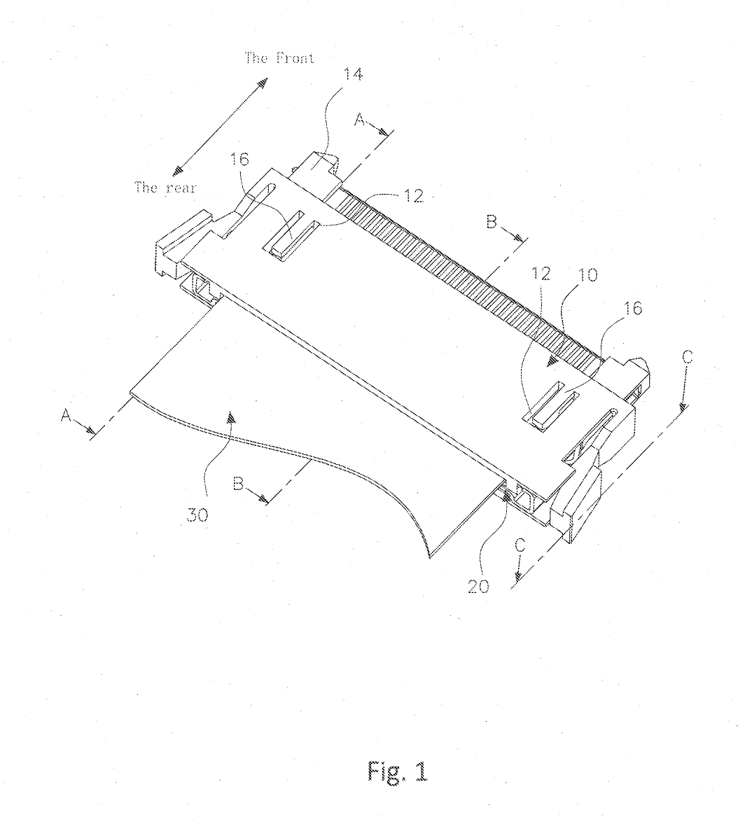

Referring to FIGS. 1 to 8, the first embodiment of the present invention, comprising an insulating body 10, a shielding housing 20 and a flat conductor 30, and said flat conductor 30 is provided with two notches 31.

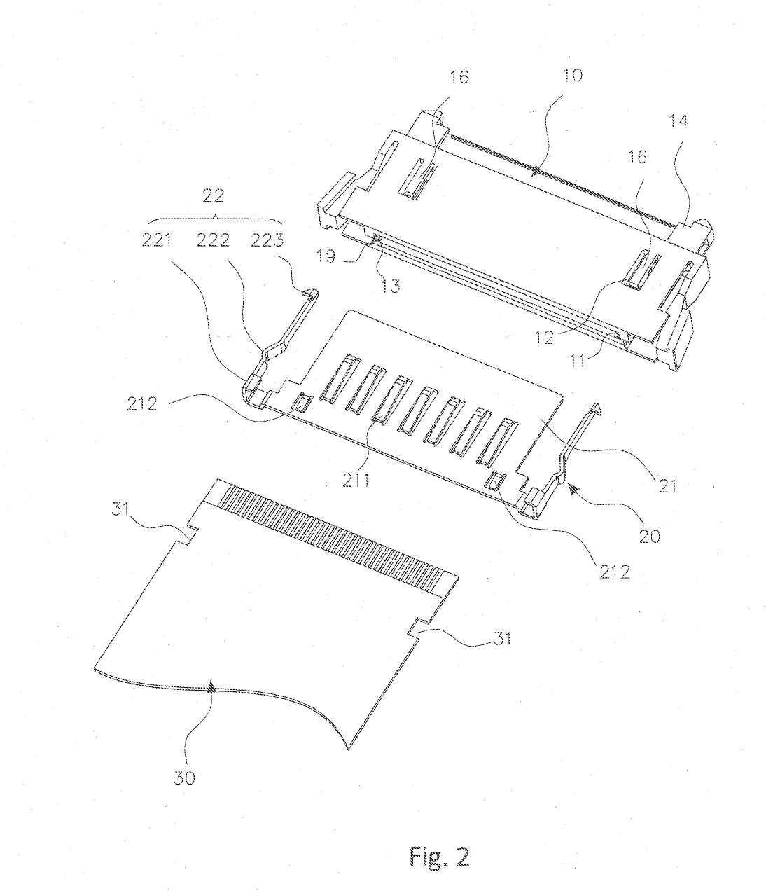

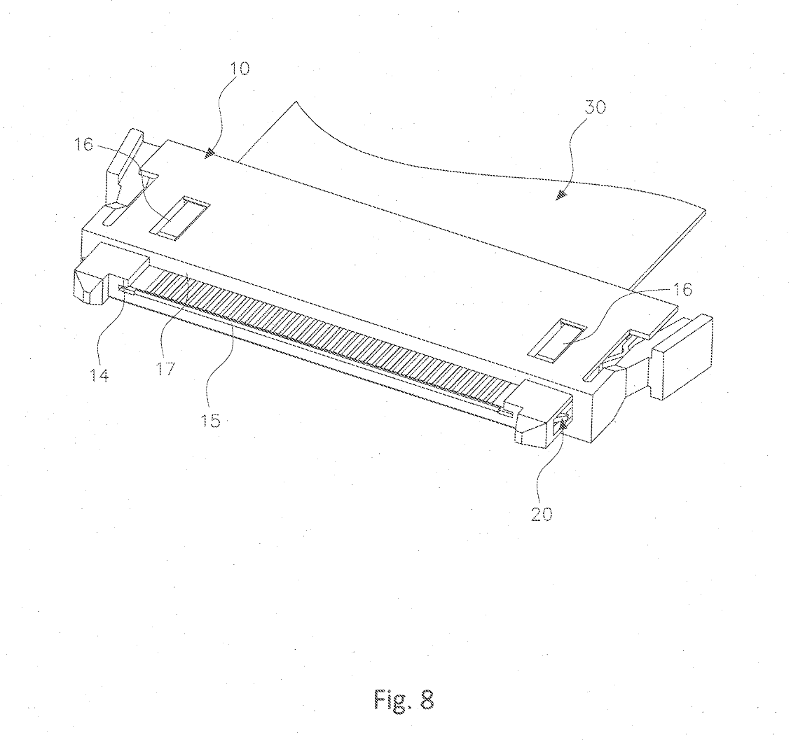

As shown in FIGS. 2 and 8, said insulating body 10 is formed integrally. A guiding slot 11 is provided on one side of the insulating body 10 to guide the front connecting part of the flat conductor 30 to the notch. On the opposite side, an inserting part is provided for the insertion with the corresponding connector. A contacting face 17 connected to said guiding slot 11 is provided on the inserting part. The connecting part on the flat conductor 30 is led in from the guiding slot 11 and positioned on said inserting part to contact with the corresponding connector. The guiding slope 13 at the rear opening of the guiding slot 11 can allow the flat conductor 30 to be inserted easily. The left and right sides of the contacting face 17 are provided with an anti-warping part 14 for pressing down the front part of the flat conductor 30 to prevent the front connecting part from tilting upwards. A limiting part 15 is provided at the protruding part of the front opening of the contacting face 17, and is used to stop the front part of the flat conductor 30 backwards, thus having a limiting effect on the front part of the flat conductor 30.

Corresponding to the locations of notches 31, two insert slots 12 are provided on the insulating body 10. After the flat conductor 30 is inserted completely into said guiding slot 11, the insert slots 12 are connected between said guiding slot 11 and the external side of the insulating body 10 along, the thickness direction of the flat conductor 30.

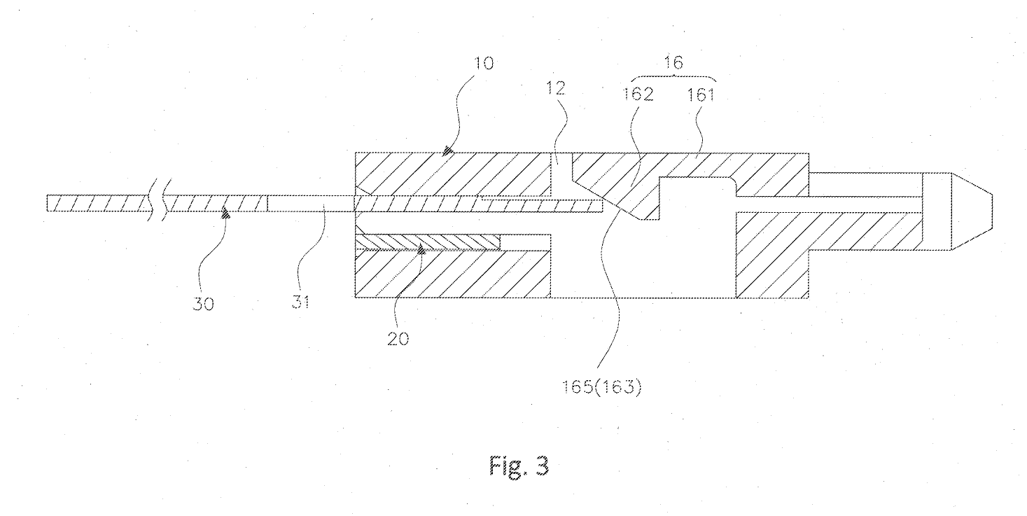

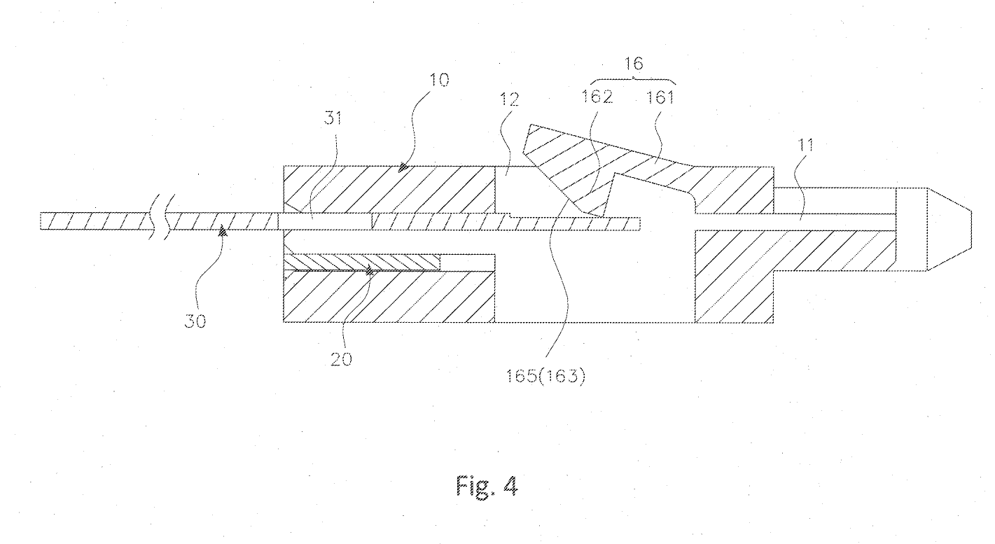

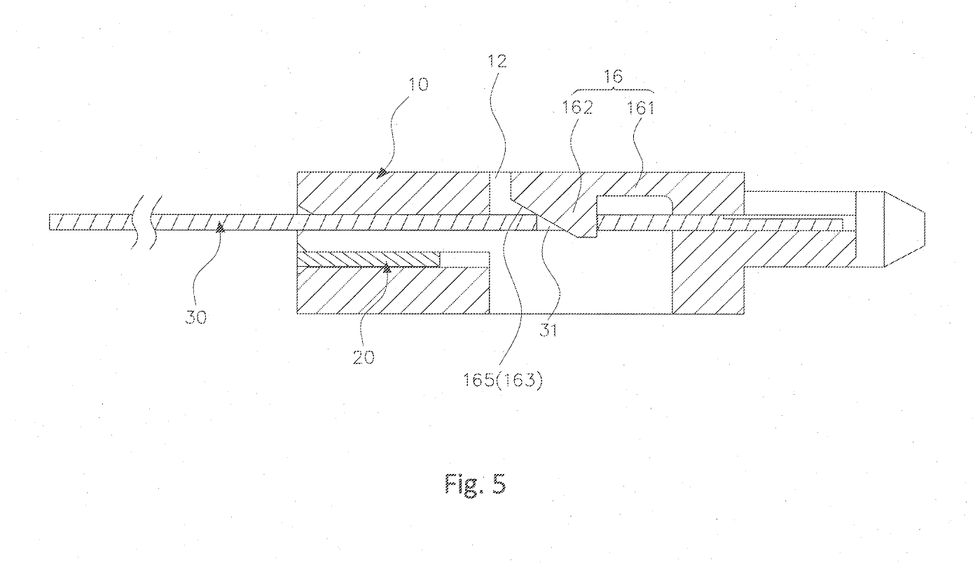

In the second holding space 12, an elastic buckling piece 16 is provided integrally on the insulating body 10. Said elastic buckling piece 16 comprises an elastic arm 161 extending laterally and a buckling part 162 extending vertically. One end of said elastic arm 161 is connected integrally onto the insulating body 10. Said buckling part 162 is formed by extending from the other end of elastic arm 161. Moreover, the guiding slope 165 is provided on the buckling part 162 for insertion of the flat conductor 30. In the natural state, the external surface of elastic buckling piece 16 does not exceed that of the insulating body 10 and its buckling part 162 extends into the guiding slot 11 (as show in FIG. 3). When the flat conductor 30 is inserted into the guiding slot 11, the guiding slope 165 of buckling part 162 is pushed by the flat conductor 30 so that the elastic arm 161 turns upwards until the buckling part 162 moves out of the guiding slot 11. When the flat conductor 30 is inserted completely, the elastic buckling piece 16 is automatically reset to buckle the flat conductor 30 (as show in FIGS. 4 and 5).

Referring to FIGS. 3 to 5, said guiding slope 165 can have a pushing slope 163, as shown in the second embodiment. Moreover, the receding groove 164 can be designed on the bottom surface of buckling part 162, as shown in the second embodiment.

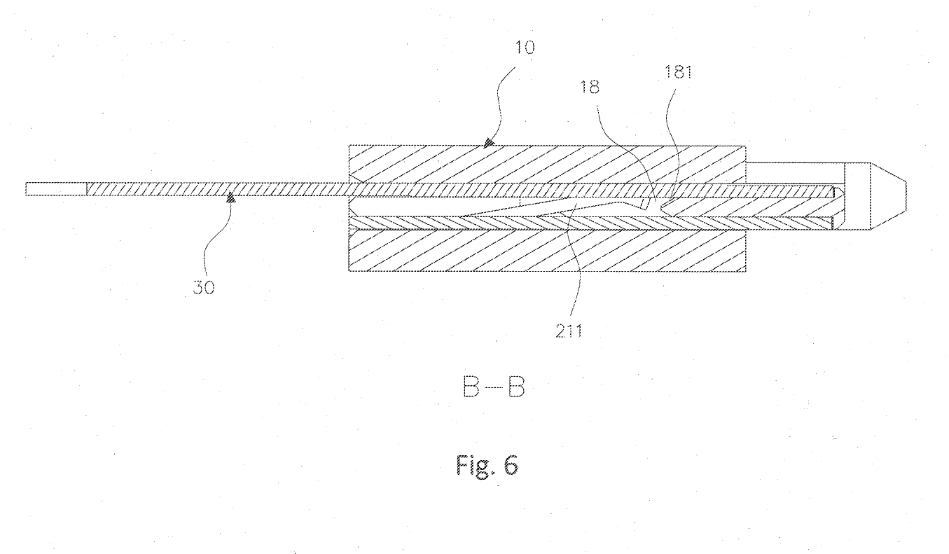

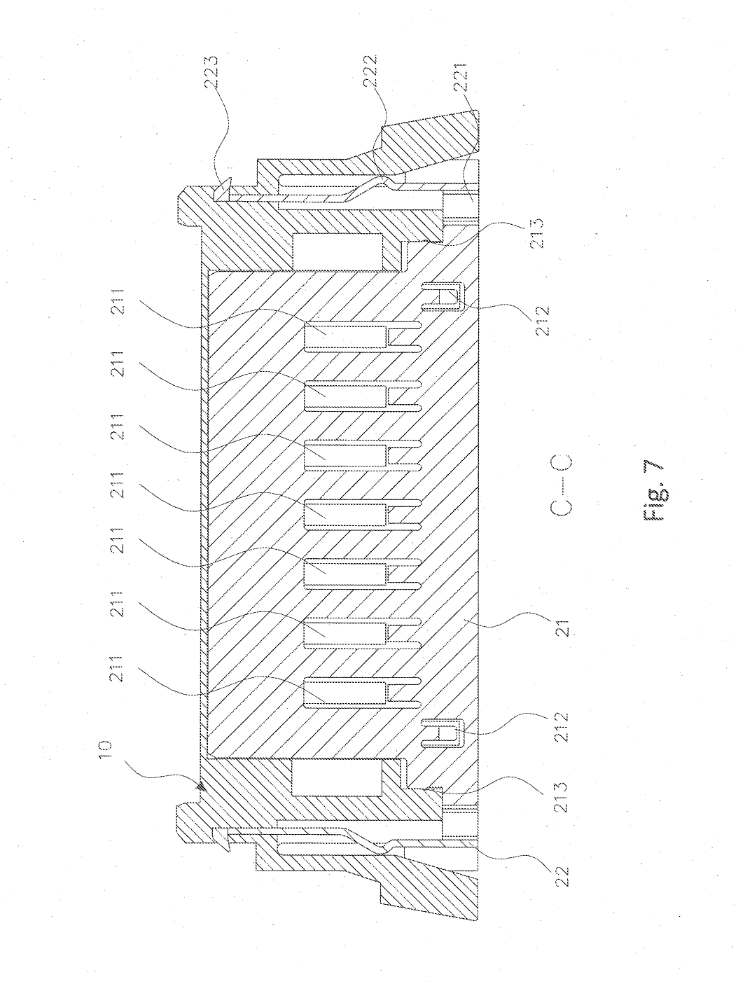

The shielding housing 20 is located inside the insulating body 10. The holding slot 19 is provided under said guiding slot 11 for the insertion of shielding housing 20. The shielding housing 20 comprises a housing substrate 21 and two hooks 22 connected to the left and right side of housing substrate 21 respectively. The hook 22 comprises a stopping part 221, an elastic compression part 222, and a hook part 223, which are connected integrally. The two stopping parts 221 are connected integrally on the left and right sides of housing substrate 21 respectively (as show in FIG. 2). The side of housing substrate 21 extends integrally outwards to form a stopping point 213. After the shielding housing 20 is assembled inside the insulating body 10, the stopping point 213 is pushed tightly onto the insulating body 10 (as show in FIG. 7). An elastic limiting point 212 is provided on the shielding housing 20. Accordingly, a limiting slot is provided on the insulating body 10 and said elastic limiting point 212 is buckled inside the limiting slot. A grounding elastic piece 211 is provided to contact with the flat conductor 30 on the shielding housing 20. A through slot 18 is formed between said housing substrate 21 and said guiding slot 11 for the movement of the grounding elastic piece 211. A guiding slant 181 is formed at the front end of through slot 18 (as show in FIG. 6) for inserting the flat conductor 30.

During assembly, the shielding housing 20 is inserted into the holding slot 19; then, the flat conductor 30 is inserted into the guiding slot 11; after the flat conductor 30 is inserted completely, said elastic buckling piece 16 is automatically reset to buckle the buckling part 162 to the notch 31 of the flat conductor 30. The assembly and connection between the connector and the flat conductor 30 is completed.

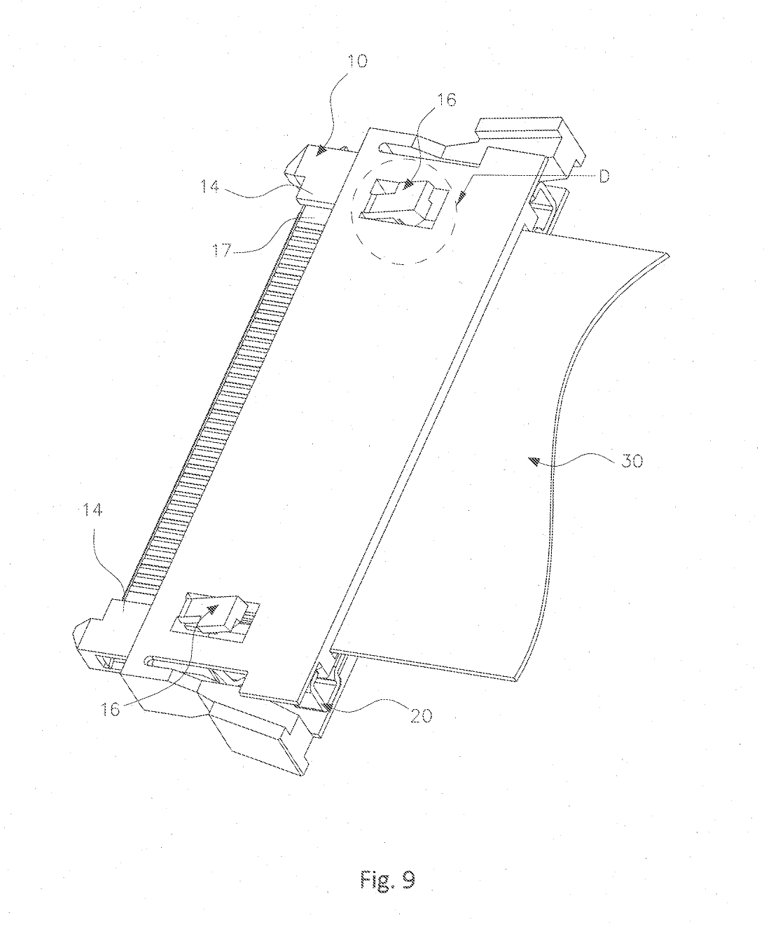

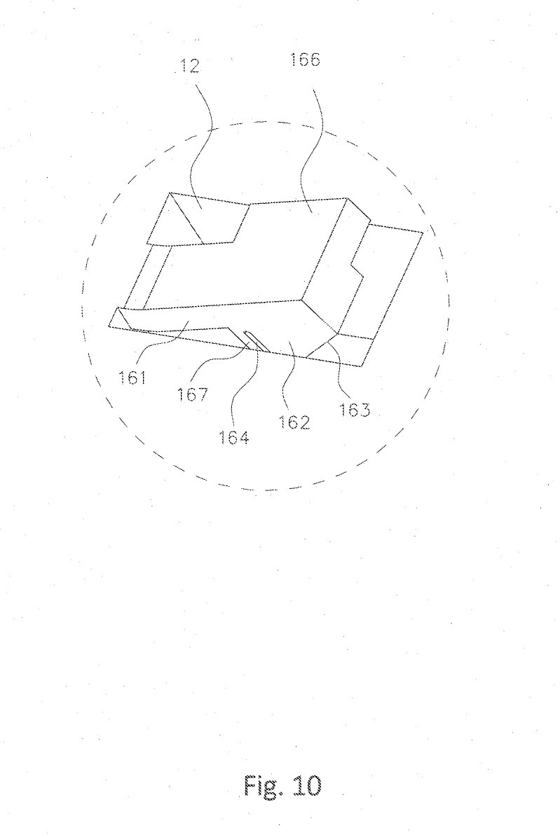

Referring to FIGS. 9 and 10, the second embodiment of the present invention has a similar structure as the first embodiment. The difference is that, in the second embodiment, the flat conductor 30 is inserted after the elastic buckling piece 16 is pushed up by the jig. Specifically, the elastic buckling piece 16 comprises the elastic arm 161 extending laterally, the buckling part 162 extending vertically, and the pressed part 166 is pushed up by the jig. One end of elastic arm 161 is connected integrally onto the insulating body 10. The buckling part 162 is formed by extending from the other end of elastic arm 161. The pressed part 166 is connected integrally onto the elastic arm 161. In the natural state, the buckling part 162 of said elastic buckling piece 16 extends into the guiding slot 11.

In addition, in this embodiment, the pushing slope 163 is provided on the buckling part 162. Under the pressure of the pushing slope 163, the surface of flat conductor 30 is in close contact with the bottom of guiding slot 11, thus effectively preventing from the upward and downward vibration of flat conductor 30. A receding groove 164 is provided for the deformation in the case that the buckling part 162 is squeezed into the notch 31 of flat conductor, and recessed upwards on the bottom surface of said buckling part 162.

As show in FIG. 10, in this embodiment, a guiding part 167 is provided on the buckling part 162. Said guiding part 167 is deformed when it is squeezed into the notch 31, so that said buckling part 162 can be easily buckled into the notch 31 of the flat conductor 30. After the buckling part 162 is buckled in the notch 31, said pushing slope 163 can be tightly pushed onto the flat conductor 30 acted by the elastic resetting force of buckling part 62. This design can be applied to the first embodiment.

During assembly, force is applied on the pressed part 166 of said elastic buckling piece 16 by the jig to push up the elastic buckling piece 16 until said buckling part 162 leaves the guiding slot 11 completely. Then, the flat conductor 30 is inserted into said guiding slot 11 where the flat conductor can pass through the pressed part by zero insertion force. After the flat conductor 30 is inserted completely into the guiding slot 11, the jig is removed, and said elastic buckling piece 16 is automatically reset to extend the buckling part 162 in the guiding slot 11 and buckle in the notch of flat conductor 30. The assembly and connection between the connector and the flat conductor 30 is completed.

The present invention provides an integral structure of the elastic buckling piece on the insulating body to be connected with the flat conductor. In the natural state, the buckling part of the elastic buckling piece extends into the guiding slot where the flat conductor is located. During assembly, the flat conductor is inserted to push the elastic buckling piece open. After the flat conductor is inserted completely, the elastic buckling piece is automatically reset to buckle the flat conductor. Alternatively, a jig is used to push up the buckling part first; after the flat conductor is inserted completely, the jig is removed, and the elastic buckling piece is automatically reset to buckle the flat conductor. The structure is simple and easy to produce, and the assembly is convenient, thereby effectively improving the production efficiency and product quality.

Although the invention has been explained in relation to its preferred embodiment, it is to be understood that many other possible modifications and variations can be made without departing from the spirit and scope of the invention as hereinafter claimed.

We claim:

1. A electrical connector for flat conductor, comprising an insulating body having an guiding slot of an opening arranged on one side thereof capable of being formed into an connecting part in front side for inserting the flat conductor therein; on the opposite side, an inserting part is provided for insertion of the corresponding connector; said inserting part has an insert slot connected to said guiding slot; the connecting part on the flat conductor is inserted from the guiding slot and positioned on said inserting part to be in contact with the corresponding connector; it is characterized that the insert slots passing through the guiding slot are provided on the insulating body along the thickness direction of flat conductor at the locations corresponding to the stopping parts of the flat conductor respectively,

1. in the insert slot, an elastic buckling piece being formed integrally on the insulating body, the elastic buckling piece including an elastic arm and a buckling part connected to the insulating body; the buckling part protruding into the guiding slot, after the flat conductor inserted, the buckling part buckled at the notch of the flat conductor by the rebound action of elastic arm to prevent the flat conductor from falling.

2. The structure as defined in claim 1, which is characterized in that a guiding slope is provided on said buckling part for the insertion of the flat conductor; by pushing the guiding slope of buckling part with the flat conductor, the buckling part is automatically pushed up under the elastic action of the elastic arm to enable the insertion of the flat conductor; finally, the buckling part is buckled at the notch of the flat conductor by the rebound action of elastic arm; after the flat conductor is inserted, the buckling part is buckled at the notch of the flat conductor by the rebound action of elastic arm to prevent the flat conductor from falling.

3. The structure as defined in claim 1, which is characterized in that said buckling part is provided with a pressed part at the external side of the flat conductor; when pushed by the external jig, the pressed part drives and pushes the buckling part up for insertion of the flat conductor; finally, the buckling part is buckled at the notch of the flat conductor by the rebound action of elastic arm.

4. The structure as defined in claim 1, which is characterized in that said buckling part is equipped with a receding groove to provide flexibility for the movement of guiding part.

5. The structure as defined in claim 1, which is characterized in that the left and right sides of said inserting part are provided with a limiting part respectively for stopping the front end of the flat conductor.

6. The structure as defined in claim 1, which is characterized in that the front end of said inserting part is provided with an anti-warping part for stopping the front end of the flat conductor.

7. The structure as defined in claim 1, which is characterized in that said connector comprises a shielding housing and left and right hooks.

8. The structure as defined in claim 7, which is characterized in that said shielding housing and left and right hooks are formed integrally; the hook comprises of a stopping part, an elastic compression part and a hook part; the stopping part is connected integrally onto the shielding housing.

9. An assembly method for electric connector and flat conductor, as defined in claim 3, which is characterized in that:
the assembly procedure is as follows:
(1) prepare an electric connector for flat conductor, a flat conductor and a jig; the jig is provided with a pushing block;
(2) use the pushing block of the jig to push the pressed part upwards in the preset procedure so that the pressed part drives and pushes the buckling part up by the action of the elastic arm; the flat conductor can pass through the pressed part by zero insertion force;
(3) insert the flat conductor from the guiding slot, and put the connecting part at its front end on the inserting part;
(4) remove the jig and restore the buckling part back to its natural state by the rebound action of elastic arm; the buckling part is extended into the guiding slot and buckled in the notch of the flat conductor.

10. The structure as defined in claim 9, which is characterized in that said buckling part is equipped with a receding groove to provide flexibility for the movement of guiding part.

11. The structure as defined in claim 9, which is characterized in that the left and right sides of said inserting part are provided with a limiting part respectively for stopping the front end of the flat conductor.

12. The structure as defined in claim 9, which is characterized in that the front end of said inserting part is provided with an anti-warping part for stopping the front end of the flat conductor.

13. The structure as defined in claim 9, which is characterized in that said connector comprises a shielding housing and left and right hooks.

14. The structure as defined in claim 13, which is characterized in that said shielding housing and left and right hooks are formed integrally; the hook comprises of a stopping part, an elastic compression part and a hook part; the stopping part is connected integrally onto the shielding housing.
